(19) United States
(12) Patent Application Publication
(10) Pub. No.: US 2016/0037402 A1
(43) Pub. Date: Feb. 4, 2016

(54) Mechanism for a Fast Handover Using Resource Pools and Random Access Procedure

(71) Applicant: NOKIA SOLUTIONS AND NETWORKS OY, Espoo (FI)

(72) Inventors: Claudio ROSA, Randers (DK); Frank FREDERIKSEN, Klarup (DK); Klaus Ingemann PEDERSEN, Aalborg (DK); Per Henrik MICHAELSEN, Aalborg (DK)

(21) Appl. No.: 14/780,022

(22) PCT Filed: Mar. 26, 2013
(86) PCT No.: PCT/EP2013/056337

§ 371 Date: Sep. 25, 2015

(51) Int. Cl. H04W 36/00; H04W 36/04

(52) U.S. Cl. CPC H04W 36/0072; H04W 36/0061; H04W 36/04

(57) ABSTRACT

An apparatus at least one processor, and at least one memory for storing instructions to be executed by the processor, wherein the at least one memory and the instructions are configured to, with the at least one processor, cause the apparatus at least: to create at least one pool of communication resources for a fast handover procedure, wherein at least one set of communication resources is allocated to a pool of communication resources, and to cause a transmission of information indicating the content of the at least one pool of communication resources to a neighboring cell for allocating the pool of communication resources to the neighboring cell.

### BACKGROUND

1. Field

The present invention relates to apparatuses, methods, systems, computer programs, computer program products and computer-readable media usable for controlling a communication in a communication network, for example with regard to a handover procedure.

2. Background Art

The following description of background art may include insights, discoveries, understandings or disclosures, or associations, together with disclosures not known to the relevant art prior, to at least some examples of embodiments of the present invention but provided by the invention. Some such contributions of the invention may be specifically pointed out below, whereas other such contributions of the invention will be apparent from their context.

Some related art can e.g. be found in technical specifications according to 3GPP TS 36.300 (e.g. version 11.4.0).

The following meanings for the abbreviations used in this specification apply:

BS: base station

CPU: central processing unit

C-RNTI: cell radio network temporary identifier

eNB: evolved node B

ID: identification, identifier

HO: handover

LTE: Long Term Evolution

LTE-A: LTE Advanced

PRACH: physical random access channel

RACH: random access channel

RAN: radio access network

RF: radio frequency

RRC: radio resource control

TA: time advance

UE: user equipment

UL: uplink

In the last years, an increasing extension of communication networks, e.g. of wire based communication networks, such as the Integrated Services Digital Network (ISDN), DSL, or wireless communication networks, such as the cdma2000 (code division multiple access) system, cellular 3rd generation (3G) and fourth generation (4G) communication networks like the Universal Mobile Telecommunications System (UMTS), enhanced communication networks based e.g. on LTE or LTE-A, cellular 2nd generation (2G) communication networks like the Global System for Mobile communications (GSM), the General Packet Radio System (GPRS), the Enhanced Data Rates for Global Evolution (EDGE), or other wireless communication system, such as the Wireless Local Area Network (WLAN), Bluetooth or Worldwide Interoperability for Microwave Access (WiMAX), took place all over the world. Various organizations, such as the 3rd Generation Partnership Project (3GPP), Telecoms & Internet converged Services & Protocols for Advanced Networks (TISPAN), the International Telecommunication Union (ITU), 3rd Generation Partnership Project 2 (3GPP2), Internet Engineering Task Force (IETF), the IEEE (Institute of Electrical and Electronics Engineers), the WiMAX Forum and the like are working on standards for telecommunication network and access environments.

Generally, for properly establishing and handling a communication connection between terminal devices such as a user device or user equipment (UE) and another communication network element or user device, a database, a server, host etc., one or more intermediate network elements such as communication network control elements, such as base stations, control nodes, support nodes or service nodes are involved which may belong to different communication network.

Basically, a communication network is typically divided into several cells controlled by a communication network control element like a BS or eNB. When a communication element or UE is moving in the network, e.g. in an RRC Connected mode (the UE is in RRC_CONNECTED mode), it enters at some time the coverage area of another cell. In this case, suitable handover functionality may be provided to maintain connectivity and services for the user device, so that the user device will be able to maintain continuous connectivity.

However, as different cells may usually have different coverage areas, and one user device may move from one cell to another, the handover mechanisms may also be used to address this.

For example, besides a classical network environment where plural cells of the same type (e.g. plural macro cells) are arranged in a neighboring manner, new approaches are provided in order to enhance the performance of communication networks. One of these approaches is the implementation of a heterogeneous network structure. A heterogeneous network may comprise e.g. a “normal” communication cell (i.e. a macro cell) controlled by a communication network control element, such as an eNB in LTE networks, and plural small cells having also an own communication network control element, which are referred to, for example, as local area or small cells controlled by a corresponding eNB or the like for a small cell. The term “small cell” is typically used to describe a low-powered radio access node or cell having a range of tens or some hundred meters. Small cells are typically designed to be used to offload mobile data traffic as a more efficient usage of radio spectrum. A heterogeneous network provides, for example, an improved coverage and the possibility for offloading from a communication in the macro cell to a small cell. The small cells are coupled, for example, to the communication network control element of the macro call by a backhaul network offering high capacity, or the like.

However, conventional handover mechanisms are based on a certain sequence of steps for coordinating resources between a source cell (from where the user device comes) and a target cell (to which the user device is to be moved), which require a certain amount of time. While such a sequence is acceptable in terms of time consumption for a classical environment, in case of a heterogeneous network structure, the required time may be seen as being too long. Furthermore, generally, a reduction of the time period required for a handover is always preferred.

### SUMMARY

According to an example of an embodiment, there is provided, for example, an apparatus comprising at least one processor, and at least one memory for storing instructions to be executed by the processor, wherein the at least one memory and the instructions are configured to, with the at least one processor, cause the apparatus at least: to create at least one pool of communication resources for a fast handover procedure, wherein at least one set of communication resources is allocated to a pool of communication resources, and to cause a transmission of information indicating the content of the at least one pool of communication resources to a neighboring cell for allocating the pool of communication resources to the neighboring cell.

Furthermore, according to an example of an embodiment solution, there is provided, for example, a method comprising creating at least one pool of communication resources for a fast handover procedure, wherein at least one set of communication resources is allocated to a pool of communication resources, and causing a transmission of information indicating the content of the at least one pool of communication resources to a neighboring cell for allocating the pool of communication resources to the neighboring cell.

According to an example of an embodiment, there is provided, for example, an apparatus comprising at least one processor and at least one memory for storing instructions to be executed by the processor, wherein the at least one memory and the instructions are configured to, with the at least one processor, cause the apparatus at least: to receive and process information indicating a content of a pool of communication resources for a fast handover procedure, wherein at least one set of communication resources is allocated to the pool of communication resources, wherein the processing comprises to allocate the received pool of communication resources to a neighboring cell and to store the information indicating the content of the pool of communication resources.

Furthermore, according to an example of an embodiment solution, there is provided, for example, a method comprising receiving and processing information indicating a content of a pool of communication resources for a fast handover procedure, wherein at least one set of communication resources is allocated to the pool of communication resources, allocating the received pool of communication resources to a neighboring cell, and storing the information indicating the content of the pool of communication resources.

In addition, according to embodiments, there is provided, for example, a computer program product for a computer, comprising software code portions for performing the steps of the above defined methods, when said product is run on the computer. The computer program product may comprise a computer-readable medium on which said software code portions are stored. Furthermore, the computer program product may be directly loadable into the internal memory of the computer and/or transmittable via a network by means of at least one of upload, download and push procedures.

### BRIEF DESCRIPTION OF THE DRAWINGS

Some embodiments of the present invention are described below, by way of example only, with reference to the accompanying drawings, in which:

FIG. 1 shows a diagram illustrating a communication network configuration where some examples of embodiments are implemented;

FIG. 2 shows a diagram illustrating a provisioning of pools of communication resources according to some examples of embodiments;

FIG. 3 shows a signaling diagram illustrating a handover procedure according to some examples of embodiments;

FIG. 4 shows a flow chart of a processing conducted in a target communication network control element with regard to a handover procedure according to some examples of embodiments;

FIG. 5 shows a flow chart of a processing conducted in a source communication network control element with regard to a handover procedure according to some examples of embodiments;

FIG. 6 shows a diagram of a communication network control element acting as a target communication network control element and including processing portions conducting functions according to some examples of embodiments; and

FIG. 7 shows a diagram of a communication network control element acting as a source communication network control element and including processing portions conducting functions according to some examples of embodiments.

### DESCRIPTION OF EMBODIMENTS

In the following, some examples and embodiments are described with reference to the drawings. In the following, different exemplifying embodiments will be described using, as an example of a communication network, an LTE-Advanced based system. However, it is to be noted that the present invention is not limited to an application using such types of communication system, but is also applicable in other types of communication systems and the like.

The following embodiments are only examples. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may also contain also features, structures, units, modules etc. that have not been specifically mentioned.

A basic system architecture of a communication network where examples of embodiments are applicable may comprise a commonly known architecture of one or more communication systems comprising a wired or wireless access network subsystem and a core network. Such an architecture may comprise one or more access network control elements, radio access network elements, access service network gateways or base transceiver stations, such as a base station or an eNB, which control a coverage area or cell (macro cell, small cell) and with which one or more communication elements or terminal devices such as a UE or another device having a similar function, such as a modem chipset, a chip, a module etc., which can also be part of a UE or attached as a separate element to a UE, or the like, are capable to communicate via one or more channels for transmitting several types of data. Furthermore, core network elements such as gateway network elements, policy and charging control network elements, mobility management entities and the like may be comprised.

The general functions and interconnections of the described elements, which also depend on the actual network type, are known to those skilled in the art and described in corresponding specifications, so that a detailed description thereof is omitted herein. However, it is to be noted that several additional network elements and signaling links may be employed for a communication to or from a communication element or terminal device like a UE and a communication network besides those described in detail herein below.

The communication network is also able to communicate with other networks, such as a public switched telephone network or the Internet. The communication network may also be able to support the usage of cloud services. It should be appreciated that eNBs or their functionalities may be implemented by using any node, host, server or access point etc. entity suitable for such a usage.

Furthermore, the described network elements, such as terminal devices or user devices like UEs, communication network control elements of a cell, like an eNB and the like, as well as corresponding functions as described herein may be implemented by software, e.g. by a computer program product for a computer, and/or by hardware. In any case, for executing their respective functions, correspondingly used devices, nodes or network elements may comprise several means, modules, units, components, etc. (not shown) which are required for control, processing and/or communication/signaling functionality. Such means, modules, units and components may comprise, for example, one or more processors or processor units including one or more processing portions for executing instructions and/or programs and/or for processing data, storage or memory units or means for storing instructions, programs and/or data, for serving as a work area of the processor or processing portion and the like (e.g. ROM, RAM, EEPROM, and the like), input or interface means for inputting data and instructions by software (e.g. floppy disc, CD-ROM, EEPROM, and the like), a user interface for providing monitor and manipulation possibilities to a user (e.g. a screen, a keyboard and the like), other interface or means for establishing links and/or connections under the control of the processor unit or portion (e.g. wired and wireless interface means, radio interface means comprising e.g. an antenna unit or the like, means for forming a radio communication part etc.) and the like, wherein respective means forming an interface, such as a radio communication part, can be also located on a remote site (e.g. a radio head or a radio station etc.). It is to be noted that in the present specification processing portions should not be only considered to represent physical portions of one or more processors, but may also be considered as a logical division of the referred processing tasks performed by one or more processors.

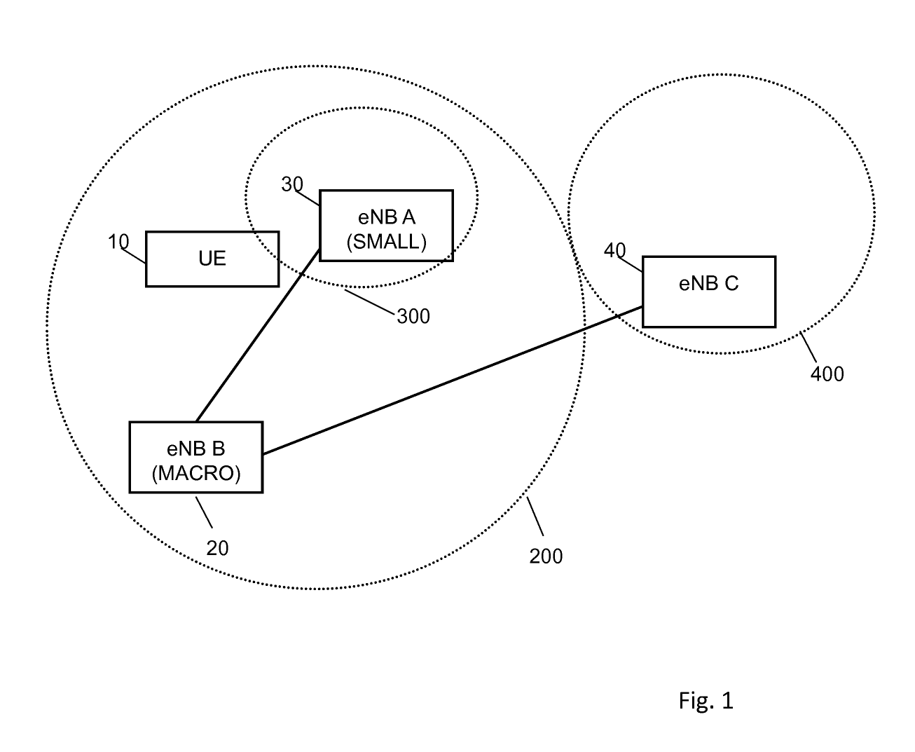

With regard to FIG. 1, a diagram illustrating a general configuration of a communication network where some examples of embodiments of the invention are implemented is shown. It is to be noted that the configuration shown in FIG. 1 shows only those devices, network elements and/or parts which are useful for understanding principles underlying the examples of embodiments. As also known by those skilled in the art there may be several other network elements or devices involved in a communication between the communication element like the user device (UE) and the network which are omitted here for the sake of simplicity.

In FIG. 1, a communication network configuration is illustrated in which some examples of embodiments are implementable. The network according to FIG. 1 is for example based on the 3GPP specifications and comprises elements of a heterogeneous network including a primary serving cell (macro cell) and one or more secondary cells (small cells), and elements of parallel (neighboring) macro cells. It is to be noted that the general functions of the elements described in connection with FIG. 1 as well as of reference points/interfaces between the elements are known to those skilled in the art so that a detailed description thereof is omitted here for the sake of simplicity.

As shown in FIG. 1, in the exemplary communication network, a communication element like a user device (such as UE) 10 is located in a macro cell 200 controlled by a (macro) eNB B 20 as a communication network control element. Additionally, the UE 10 is located in a small cell 300 controlled by a (small) eNB A 30 as a communication network control element. The cells 200 and 300 are hereinafter referred to as neighboring cells as their coverage areas are (at least partly) overlapping, allowing an execution of a handover procedure therebetween.

As also depicted in FIG. 1, the communication network comprises a further element formed by a neighboring cell 400 controlled by an eNB C 40 as a communication network control element. Here, the cells 200 and 400 are assumed to be neighboring cells.

It is to be noted that the term “neighboring cell” is to be understand in such a manner that the respective cells have at least partly overlapping coverage areas for their radio connections towards a communication element so that it is possible that the radio connection of a communication element is moved (if possible without interruption) from one cell to the other cell of the neighboring cells. In other words, neighboring cells are those cells which represent candidates for a handover to and from each other, wherein of course more than two cells can be neighboring cells to each other, depending on the current network architecture etc.

The communication element or terminal device UE 10 is configured to communicate with the communication network via at least one of the eNB B 20, eNB A 30 or eNB C 40 by using, for example, an air interface.

The communication network control elements eNB A 30, eNB B20 and eNB C 40 are connected by suitable interfaces and a backhaul network, for example by means of so-called X2 interfaces which are used to exchange messages and information between the communication network control elements and to enable the nodes to directly communicate with each other.

It should be appreciated that according to some examples, a so-called “liquid” or flexible radio concept is employed where the operations and functionalities of a communication network control element or of another entity of the communication network, such as of one or more of the shown eNBs, may be performed in different entities, such as a node, host or server, in a flexible manner. In other words, a “division of labour” between involved network elements or entities may vary case by case. One possible alternative to the example illustrated is, for example, is to make a base station or the like to deliver local content.

It is to be noted that even though FIG. 1 shows three cells 200, 300, 400, the number of cells is not limited thereto and can be more or less than three, wherein at least two cells are neighboring cells.

In the example shown in FIG. 1, it is now assumed that the UE 10 is originally coupled to the small cell (i.e. the eNB A 30 provides, for example, a connection to a core network (not shown in FIG. 1) of the communication network). Due to mobility reasons or connection quality changes, it is now assumed that the connection of the UE 10 is to be switched from cell 300 to another (neighboring) cell, which is cell 200. Consequently, a handover procedure is to be conducted for the UE 10 to switch the connection from eNB A 30 (representing the source eNB) to the eNB B 20 (representing the target eNB).

In the following, a comparative example of a handover procedure is described which is used, for example, in conventional systems. It is to be noted that an actual handover procedure according to the comparative example may comprise additional steps which are omitted here for the sake of simplicity.

In order to be able to decide whether a handover is required, the communication network control element requires for example connection quality related measurements conducted by itself and the UE. Consequently the UE is configured to perform such measurements and to send a measurement report when e.g. a certain trigger is present (for example, in case it is observed by the UE that certain conditions or parameters are above or below a given threshold (measurement conditions) and make a handover necessary.

That is, in a system comparable to that of FIG. 1, the UE (UE 10) is triggered to conduct a transmission of a measurement report to the current serving eNB (e.g. eNB A 30 as the current base station that the UE 10 is connected to) which becomes thus the source eNB of the handover. For example, the measurement report contains information usable as an identification of a cell or eNB which is seen as a target eNB for the handover (i.e. the base station of which e.g. the communication quality is best and represents hence the preferred target for the UE 10, e.g. eNB B 20). The measurement report is transmitted by using e.g. RRC signaling from the UE to the source eNB.

When receiving the measurement report (which represents more or less a handover request), the source eNB decides whether to conduct a handover, and if the decision is affirmative, it sends a handover request to the target eNB (corresponding to eNB B 20). This signaling is handled over the X2 interface between the eNBs.

The target eNB prepares for the handover and provides information to the source eNB with information regarding resources to be used by the UE 10 for the handover. These resources comprises, for example, a temporary identifier to be used by the UE 10 in the new cell, such as a C-RNTI, and a random access channel related preamble such as a PRACH preamble to be used by the UE 10 in the access procedure to the new cell. Again, this information is handled over the X2 interface between the eNBs.

The source eNB now sends a handover command to the UE, by means of which the UE is instructed which resources are to be used when accessing the new target cell. This signaling is carried by using RRC signaling (e.g. by using an RRC_reconfiguration message).

The UE attempts to access the target eNB with the given PRACH preamble (a given physical resource), i.e. the handover procedure is continued by accessing the new cell.

When receiving the access request from the UE, the target eNB responds to the requesting UE for example with a message which is “signed” with the C-RNTI that was assigned to the UE beforehand and transmitted via the X2 interface to the source eNB. Furthermore, additional information is provided to the UE, such as different radio channel parameters to be used, like the time advance (TA) value to be used, a transmit power level, etc.

When the handover is completed (also by switching paths with regard to the core network), the target eNB (which becomes the new serving eNB for the UE) informs the old (source) eNB that the handover is completed.

It is to be noted that during the handover described above, the source eNB takes care that data directed to the UE is forwarded to the target eNB until the core network makes the switch of the traffic flow.

However, as described above, in a handover mechanism based on the above described comparative example, the sequence of steps (required for coordinating resources between the source eNB and the target eNB) requires a certain amount of time (caused, for example, by the communication via the X2 interface). For example, it can be assumed in the comparative example that the total handover preparation and execution delay is approximately 80-100 ms, wherein 40-50% of the delay is caused by signaling exchange between eNBs (via the X2 interface) and the other 40-50% of the delay is caused by the communication via the air interface for setting up the handover (the remaining delay comes from the final connection establishment to the target eNB).

According to some examples of embodiments, in order to accelerate the handover procedure, the delay caused by the communication between the eNBs (source and target) during the handover procedure may be reduced. According to some examples of embodiments, for this purpose, a “proxy” or resource pool functionality at the source eNB is implemented.

That is, according to some examples of embodiments, as one part, a concept of creating a pool of communication resources for a fast handover (or for enabling a low-latency handover) is provided. This pool of communication resources may be maintained at the source eNB and it may be coupled/allocated to specific target eNBs. In addition, as a second part, according to some examples of embodiments, mechanisms are provided allowing to facilitate maintenance of such a pool of communication resources, e.g. by signaling over an established interface (X2 or similar) between the eNBs.

For example, according to some examples of embodiments, the resources or sets of communication resources forming a pool of communication resources may comprise at least PRACH resources (PRACH preambles) and associated C-RNTI resources.

By virtue of some embodiments, it is possible to provide an enhanced mechanism for controlling a handover procedure of a communication element or user device between different cells of a communication network. That is, it is possible to provide apparatuses, methods, systems, computer programs, computer program products and computer-readable media which allow, for example, that a fast handover procedure of a communication element is conducted. According to some examples of embodiments, it is possible to reduce signaling between communication network control elements, such as an inter-eNB signaling, during an actual handover procedure, which enables low-latency handovers. For example, according to some examples of embodiments, the amount of signaling required between a source and a target eNB during the handover process may be reduced or even made unnecessary, which in turn accelerates the handover. This is in particular useful in heterogeneous network scenarios when conducting a handover to/from a small cell. Moreover, management operations enabling this acceleration during the actual handover, such as operations for providing and maintaining the pool of communication resources at the respective communication network control elements, may be executed, for example, at times with low traffic load on interfaces between the eNBs.

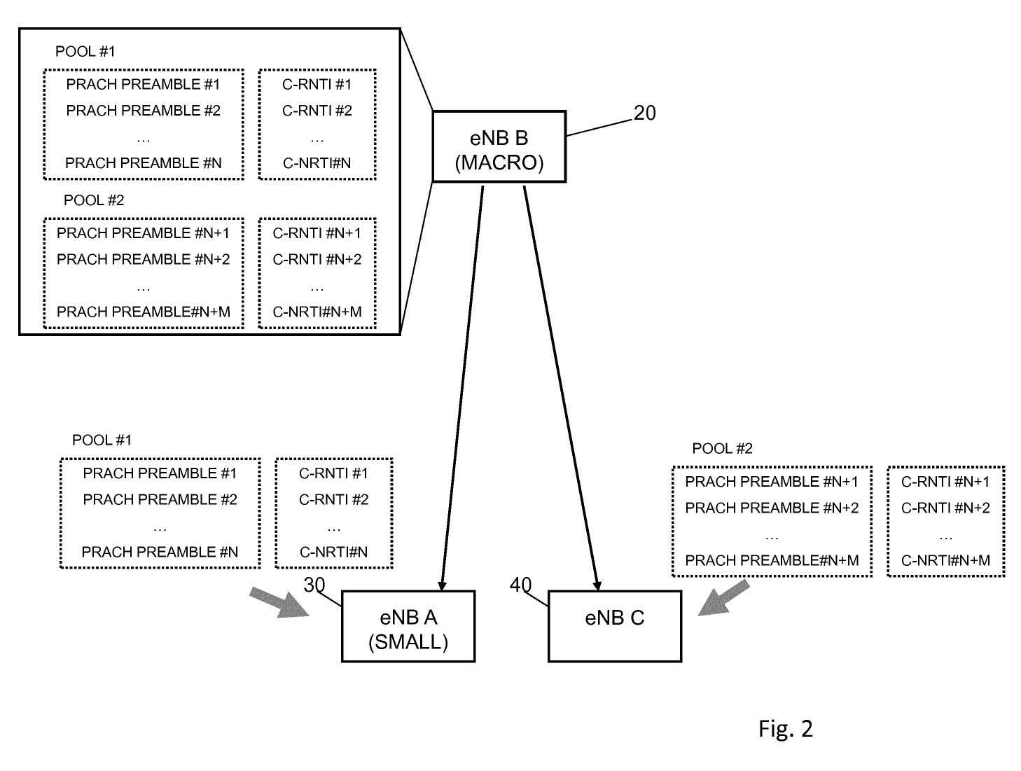

FIG. 2 shows a diagram illustrating a provisioning of pools of communication resources according to some examples of embodiments.

With regard to the resource pool functionality indicated above, for preparing a fast handover procedure according to some examples of embodiments, neighboring cells, i.e. communication network control elements such as eNBs (e.g. eNB A 30 and eNB B 20, or eNB C 40 and eNB B 20 in FIG. 1) exchange information related to resources that are allowed to be used for a fast handover in connection with a pre-reserved pool of communication resources for a fast handover. In the illustrated example, for the sake of simplicity, a case is described where respective two eNBs exchange the information, wherein one of the eNBs is assumed to act as a target eNB (i.e. the eNB to which the UE is to be handed over, which therefore has to provide the resource information), and the other of the eNBs is assumed to act as the source eNB (i.e. the eNB from which the UE is to be handed over, which therefore has to store the resource information). However, examples of embodiments are not limited to such a scenario. For example, more than one pool of communication resources can be provided and stored.

As the described example is related to eNBs as communication network control elements, the signaling related to the information exchange takes place over corresponding X2 interfaces, but it is obvious that according to further examples of embodiments of the invention, when other communication network control elements than eNBs are concerned, similar interfaces different to the X2 interface can be used, dependent on predefined network setup parameters.

Referring now to the example of FIG. 2, the eNB B 20 creates plural pools of communication resources (pool #1, pool #2), each of which is provided with plural sets of communication resources, wherein each set of communication resource comprises at least a PRACH preamble (#1 to #N for pool #1; #N+1 to #N+M for pool #2) and a C-RNTI (#1 to #N for pool #1; #N+1 to #N+M for pool #2).

For example, according to some examples of embodiments, the neighboring eNBs of eNB B 20, i.e. eNB A 30 and eNB C 40, request from the eNB B 20 an allocation of one or more sets of communication resources, i.e. PRACH preambles and associated C-RNTIs, which are reserved for fast handover from eNB A 30 (or eNB C 40) to eNB B 20.

The eNB B 20 may check the requests and determine a specified number of sets of resources which can be reserved for a fast handover. For example, the eNB B 20 determines an amount of resources which is requested by the neighboring cells, and determines an amount of resources which are generally available. Furthermore, according to examples of embodiments, it estimates a need for resources related to each requesting eNB, considers possible requests from other eNBs, and estimates the overall usage of PRACH to the eNB B 20. On the basis thereof, it may agree to the requested amount of resources or increases or decreases a number of resources allocated to the reserved resources. That is, the amount of resources reserved for fast handover may be determined by the eNB B 20 and may for instance be less that requested by he eNB A 30, e.g. in case there are not enough resources available.

Thus, respective pools of communication resources (pool #1 and pool #2) may be created by the eNB B 20, as shown in FIG. 2.

It is to be noted that the neighboring eNBs can repeat a request for allocating resources when, for example, a requirement for a higher or lower amount determined on the respective eNB side. However, also in this case the decision regarding the amount of resources to be allocated is on the eNB B 20 side.

Next, the requesting neighboring eNBs may be provided with a pool of communication resources. For example, as indicated in FIG. 2, the eNB A 30 is provided with pool #1, and the eNB C 40 is provided with pool #2. That is, e.g. on the eNB A 30, the sets of communication resources indicated in the pool #1 are allocated to be used for a handover to eNB B 20.

The provision of the pools (i.e. of information indicating the content of the respective pool) is executed via X2 interface, for example, as a response to a request from the respective eNB, or when a modification of the contents of the pool is to be conducted (for example, due to changes in an estimated usage or the like requiring a higher amount of resources).

It is to be noted that according to some examples of embodiments, when a modification of the contents of a pool requires to decrease the number of sets of communication resources, the corresponding eNB (e.g. eNB A 30) has to acknowledge the freeing of the resources. This implies that the freed resources are no more in use for fast handover from the eNB A 30 to the eNB B 20. According to some examples of embodiments, in case the acknowledgement is not provided, the modification is cancelled.

It is to be noted that according to some examples of embodiments, a modification procedure is also conducted by the eNB B 20 in case a handover from e.g. eNB A 30 to eNB B 20 is performed, where the UE uses one of the pre-assigned sets of communications resources (i.e. a PRACH preamble and C-RNTI pair). In this case, as will be described below, according to some examples of embodiments, the eNB B 20 informs the source eNB (eNB A 30) after a successful handover to the eNB B 20, wherein also an update of the pool of communication resources (i.e. of the pre-assigned sets of communication resources (comprising PRACH preamble and C-RNTI) that the eNB A 40 is afterwards allowed to use for UEs making a handover from the eNB A 30 to eNB B 20 is considered (i.e. the used set of communication resources is removed or replaced in the pool #1).

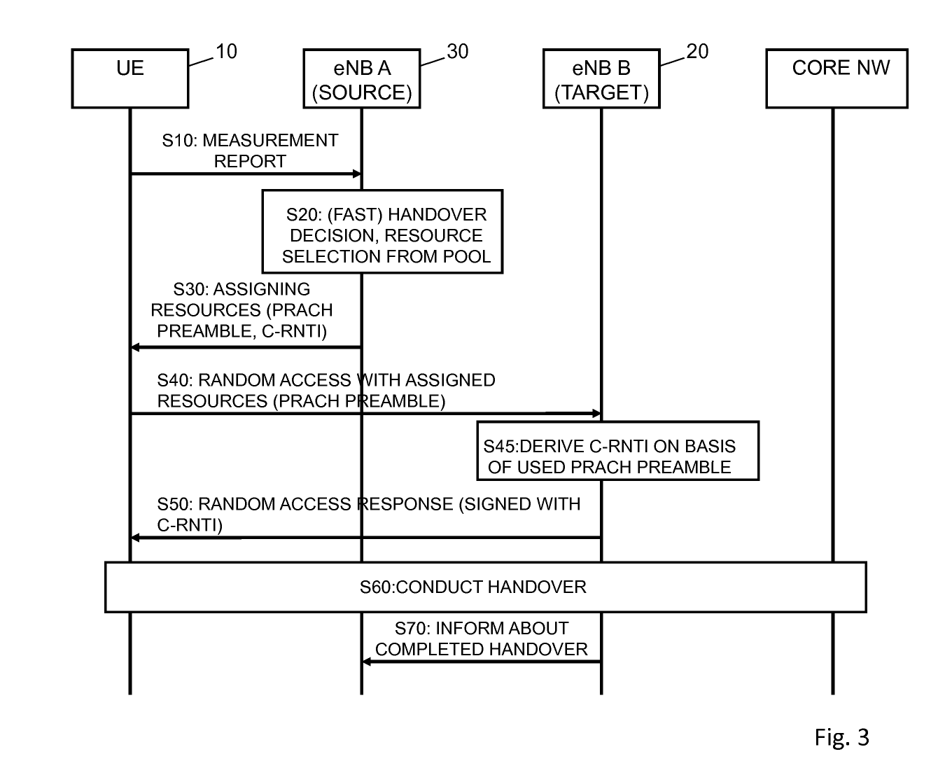

FIG. 3 shows a signaling diagram illustrating a handover procedure according to some examples of embodiments.

Assuming that, in accordance with a processing as described in connection with FIG. 2, the pools of communication resources are created and provided to the possible source eNBs (e.g. pool #1 to eNB A 30) which in turn have allocated the information to the possible target eNB (e.g. eNB B 20), i.e. the pre-assigned resources (PRACH preambles and associated C-RNTIs) for a fast handover of a UE between eNBs (i.e. eNB A 30 as source eNB and eNB B 20 as a target eNB), according to some examples of embodiments, a corresponding fast handover procedure is conducted as illustrated in FIG. 3.

As already described in connection with the comparative example, in order to be able to decide whether a handover is required, the communication network control element serving a UE requires for example connection quality related measurements conducted by itself and the UE.

Consequently, in S10, the UE 10 may perform such measurements and send a measurement report when e.g. a certain trigger is present (for example, in case it is observed by the UE 10 that certain conditions or parameters are above or below a given threshold (measurement conditions) and make a handover necessary for moving from the current cell (e.g. cell 300) to another cell.

That is, in the system according to FIG. 1, the UE 10 may be triggered to conduct a transmission of a measurement report to the current eNB A 30 as the current base station that the UE 10 is connected to. For example, the measurement report comprises information usable as an identification of a cell or eNB which is seen as a target eNB for the handover (i.e. the base station of which e.g. the communication quality is best and represents hence the preferred target for the UE 10, e.g. eNB B 20). The measurement report may be transmitted by using e.g. RRC signaling from the UE to the source eNB.

In S20, when receiving the measurement report (which represents more or less a handover request), the eNB A 30 may decide whether to conduct a handover.

When the handover decision is affirmative, according to some examples of embodiments, it is checked whether a pool of communication resources for a fast handover procedure is allocated at the eNB A 30 for the target eNB (here, eNB B 20). If this is the case, a set of communication resources is selected from the pool (e.g. pool #1 of FIG. 2) and assigned to the UE 10 (otherwise, in case no pool of communication resources is allocated, a normal handover procedure as described above may be conducted). That is, the source eNB assigns one set of communication resources (PRACH preamble and associated C-RNTI) to the UE 10 via RRC signaling in S30.

According to some additional examples of embodiments, the source eNB (e.g. eNB A 30) conducts in connection with the processing in S20 and S30 for deciding on a handover and for assigning a set of communication resources to a UE (here UE 10) a selection processing in which it is decided whether the communication element like the UE sending the measurement report (i.e. requesting the handover) is allowed to perform a fast handover procedure, i.e. whether the UE in question is determined to be allowed to be provided with one of the sets of communication resources for fast handover. For example, the source eNB conducts a priorization of subscribers or user devices (UEs) so that the fast handover procedure is open only for a selected subset of users having a corresponding priority level. The allowance for being provided with a set of communication resources of the pool of communication resources may also depend on a current load situation or on a number of available sets of resources which, in combination with a priority level of the user, is considered by the source eNB in a decision of whether or not providing the UE with a set of communication resources from the pool or not (i.e. whether a fast handover or a normal handover is decided).

When receiving the information regarding the set of communication resources assigned to the UE 10, according to some examples of embodiments, the UE 10 starts the (fast) handover e.g. by random access in the new target cell (e.g. cell 200 and eNB B 20). For this purpose, the UE 10 attempts to access the target eNB B 20 by means of a random access with assigned resources, e.g. with the given PRACH preamble, in S40. That is, the UE 10 continues the handover procedure by accessing the new cell.

When receiving the access request from the UE 10, the target eNB B 20 derives in S45, on the basis of the used PRACH preamble, the associated C-RNTI. Consequently, the eNB B 20 responds in S50 to the random access request of the requesting UE 10, for example, with a message which is “signed” with the C-RNTI that was assigned to the UE 10 beforehand and transmitted via the X2 interface to the source eNB A 30. Furthermore, according to some examples of embodiments, in S50, additional information are provided to the UE 10, such as different radio channel parameters to be used, like the time advance (TA) value to be used, a transmit power level, etc.

Then, in S60, the handover to the new target cell (eNB B 20) is completed.

When the handover is completed (also by switching paths with regard to the core network), the target eNB B 20 (which becomes the new serving eNB for the UE) informs the old (source) eNB A 30 that the handover is completed. The source eNB takes care that data is forwarded to the target eNB until the core network makes the switch of the traffic flow.

As described above, when using the handover procedure as discussed in connection with FIGS. 2 and 3, no X2 signalling is required between the source and target eNB during the handover process, and therefore the handover becomes faster. This is especially useful for heterogeneous network scenarios for handover to/from small cells.

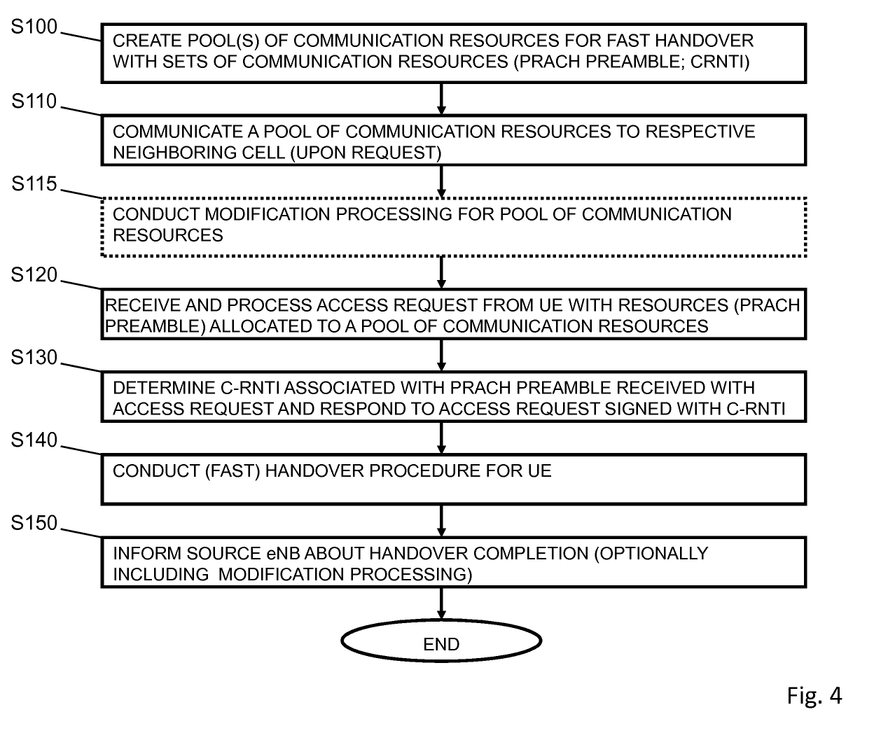

FIG. 4 shows a flowchart illustrating a processing executable in a communication network control element acting as the target eNB, like the eNB B 20 of FIG. 1, according to some examples of embodiments.

In S100, at least one pool of communication resources for a fast handover procedure is created, wherein at least one set of communication resources is allocated to a pool of communication resources. According to some examples of embodiments of the invention, a set of communication resources comprises at least one dedicated preamble for a random access channel (PRACH preamble) and one temporary identifier in a cell radio network (C-RNTI), wherein the temporary identifier is associated to the dedicated preamble of the random access channel (one-to-one mapping).

Additionally, according to some examples of embodiments, the creation of the pool of communication resources is based on a determination of a required number of sets of communication resources which is deemed to be required for the pool of communication resources (i.e. an amount of communication resources to be allocated to a pool of communication resources), which is determined on the basis of an estimated amount of usage of a random access procedure and an available amount of communication resources. Alternatively or additionally, according to some examples of embodiments, before creating the pool of communication resources, a corresponding request for allocating a specified amount of sets of communication resources for conducting a fast handover procedure is received from a neighboring cell, wherein the request is processed so as to determine the required number of sets of communication resources for the pool of communication resources.

In S110, a transmission of information indicating the content of the at least one pool of communication resources to a neighboring cell (e.g. in response to a request of a neighboring cell requesting the allocation of resources) is caused. Thus, the corresponding pool of communication resources may be allocated to the neighboring cell.

According to some examples of embodiments, in case there are more than one neighboring cells to which a pool of communication resources is to be allocated, a separate pool of communication resources for a fast handover procedure is created for each of the neighboring cells, wherein corresponding information indicating the content of each of the separate pools of communication resources to the corresponding neighboring cell is transmitted so as to allocate this pool of communication resources to the corresponding neighboring cell.

Next, according to some examples of embodiments, S115 is considered. It is to be noted that S115 is not necessarily conducted so that it is to be seen as an optional step. Specifically, in S115 a modification processing for changing a content of a pool of communication resources already allocated to a neighboring cell is conducted.

According to some examples of embodiments, the modification processing comprises at least one of: increasing and decreasing of the number of sets of communication resources allocated to the pool of communication resources, and/or replacing at least one of the sets of communication resources allocated to the pool of communication resources by another set of communication resources.

The processing according to S115 may also comprise a transmission of information indicating the modified content of the pool of communication resources to the neighboring cell after the modification processing.

According to some examples of embodiments, the modification processing in S115 is triggered by a received modification request from the neighboring cell requesting to modify the content of the allocated pool of communication resources.

According to some examples of embodiments, when the modification comprises, for example, to decrease the number of sets of resources (i.e. to release a set of communication resources (e.g. a PRACH preamble/C-RNTI pair) from the pool of communication resources allocated beforehand, the modification processing comprises also to receive and process an acknowledgement for accepting the modified pool of communication resources at the neighboring cell. In other words, according to some examples of embodiments, the neighboring cell has to accept the reduction of resources.

Next, S120 is conducted which concerns the start of a handover procedure of a UE (e.g. UE 10) to the target eNB (e.g. eNB B 20). Specifically, in S120, an access request from the UE is received and processed by means of which the UE requests an establishment of a communication connection to the target eNB. According to some examples of embodiments, the access request uses communication resources allocated to the at least one pool of communication resources for a fast handover procedure which has been allocated to the neighboring cell forming now the source cell.

In S130, by using the known contents of the pool of communication resources being allocated to a neighboring cell which is the source cell of the handover, by using the resource (PRACH preamble) used in the access request and the one-to-one mapping thereof to another resource (C-RNTI), it is possible to identify/determine from the corresponding allocated set of communication resources the other resources (e.g. the C-RNTI).

The thus identified C-RNTI may be used for signing a response to the access request so that the handover procedure can be conducted or continued in S140.

That is, according to some examples of embodiments, it is determined in the access request that a preamble for a random access channel comprised in the set of communication resources is used, wherein on the basis of the determined preamble for the random access channel the associate temporary identifier in a cell radio network, which forms with the preamble of the random access channel a pair in the set of communication resources is identified, so that this identified temporary identifier is then used in a response to the access request.

In S150, when the fast handover procedure is completed with the UE, the source eNB (i.e. the neighboring cell to which the pool of communication resources comprising the set of communication resources used in the access request and the fast handover procedure has been allocated) may be informed about the completion of the fast handover procedure.

According to some examples of embodiments, as a further option in connection with the information about the completion of the handover, a (further) modification processing for changing the content of the pool of communication resources allocated to the neighboring cell is conducted, in which the set of communication resources used in the currently completed access request and fast handover procedure is removed or replaced.

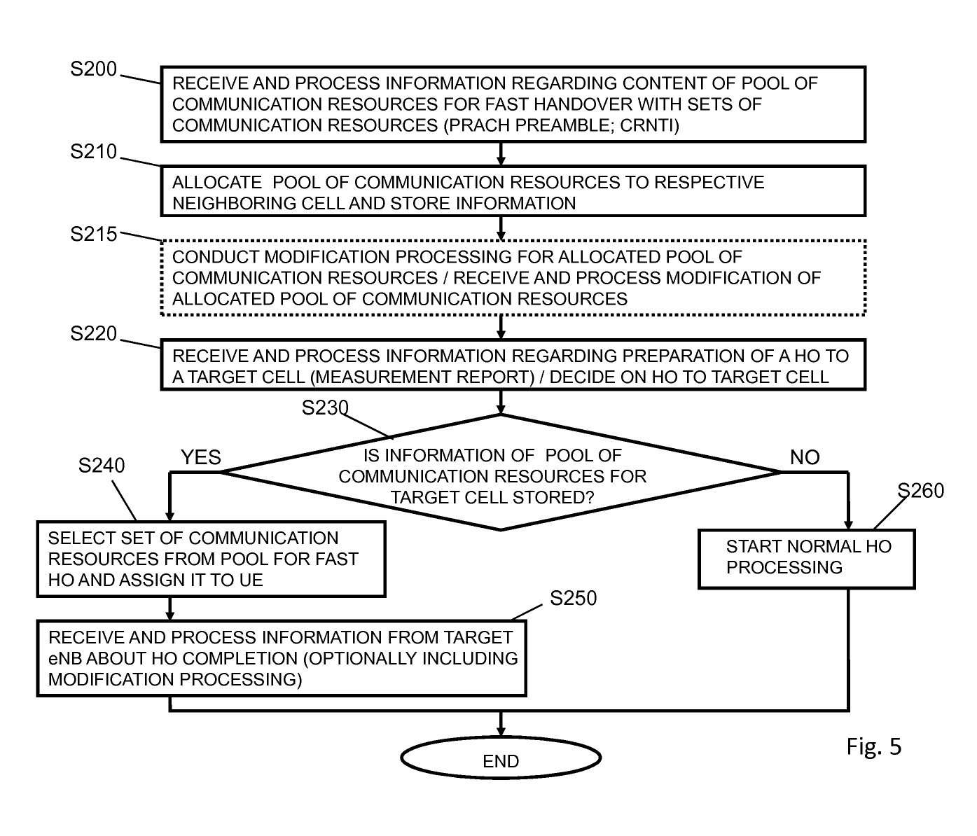

FIG. 5 shows a flowchart illustrating a processing executable in a communication network control element acting as the source eNB, like the eNB A 30 of FIG. 1, according to some examples of embodiments.

In S200, information indicating a content of a pool of communication resources for a fast handover procedure is received from a neighboring cell and processed, wherein at least one set of communication resources is allocated to the pool of communication resources. According to some examples of embodiments, a set of communication resources comprises at least one dedicated preamble for a random access channel (PRACH preamble) and one temporary identifier in a cell radio network (C-RNTI), wherein the temporary identifier is associated to the dedicated preamble of the random access channel (one-to-one mapping).

Moreover, according to some examples of embodiments, before receiving the information indicating the content of the pool of communication resource, an allocation of a specified number of sets of communication resources for conducting a fast handover procedure is requested at a neighboring cell, wherein the received information indicating the content of the pool of communication resource is a response to the request. In addition, according to some examples of embodiments of the invention, a required number of sets of communication resources for a fast handover procedure is determined on the basis of an estimated amount of usage of a random access procedure, wherein the request of the allocation of the specified number of sets of communication resources is made on the basis of the determined required number of sets of communication resources.

In S210, the received pool of communication resources may be allocated to the neighboring cell from which the information is received, wherein the information indicating the content of the pool of communication resources is stored for a later processing in a handover procedure.

Next, according to some examples of embodiments, S215 is considered. It is to be noted that S215 is not necessarily conducted so that it is to be seen as an option. Specifically, in S215, a modification processing for changing a content of the allocated pool of communication resources being allocated by the neighboring cell is conducted.

According to some examples of embodiments, the modification processing comprises to request a modification processing for changing the content of the pool of communication resources allocated by the neighboring cell, wherein the modification processing comprises at least one of increasing and decreasing of the number of sets of communication resources allocated to the pool of communication resources, and/or replacing of at least one of the sets of communication resources allocated to the pool of communication resources. In other words, the eNB having received the information indicating the content of the pool of communication resource (in FIG. 1, eNB A 30) requests a modification of the sets of communication resources due to some reason (e.g. when determining that a higher amount of resources is required).

Alternatively, according to some examples of embodiments, in the modification processing in S215, an information indicating a modification of the content of the pool of communication resources allocated by the neighboring cell is received and processed, wherein the modification comprises at least one of increasing and decreasing of the number of sets of communication resources allocated to the pool of communication resources and/or replacing at least one of the sets of communication resources allocated to the pool of communication resources. In other words, the eNB having provided the information indicating the content of the pool of communication resource (in FIG. 1, eNB B 20) instructs a modification of the sets of communication resources due to some reason (e.g. when determining that less resources are available so that a lower amount of resources is required). Furthermore, according to some examples of embodiments, when an instruction for modifying the sets of communication resources is received, an acknowledgement is sent to the neighboring cell providing the information indicating the content of the pool of communication resource, the acknowledgment indicates an acceptance of the modified pool of communication resources.

In S220, a handover procedure of the UE (UE 10) from the present source eNB (eNB A 30) to the target eNB (eNB B 20) is started. According to some examples of embodiments, at first, information regarding a preparation of a handover procedure to be conducted for a UE is received and processed. For example, according to some examples of embodiments of the invention, the information regarding preparation of a handover procedure comprises a measurement report received from the UE.

Furthermore, on the basis of the information regarding the preparation of the handover procedure, it is decided whether the handover is to be executed. If yes, the target cell (or target eNB) of the handover procedure is determined on the basis of the information regarding preparation of a handover procedure (e.g. an indication which cell has the best measurement results).

In S230, it is decided whether or not in S210 information indicating the content of a pool of communication resources being allocated by the determined target cell is stored. In other words, it is decided in S230 whether a pool of communication resources for a fast handover procedure is provided by the target cell so that a corresponding fast handover procedure can be conducted.

In case the decision in S230 is negative, S260 may be conducted in which a normal handover procedure is executed comprising e.g. the X2 communication between the source and the target eNBs.

Otherwise, in case the decision in S230 is affirmative, i.e. there is a pool of communication resources allocated by the target eNB, S240 is conducted. In S240, when for the target cell of the handover procedure information indicating a content of a pool of communication resources for a fast handover procedure is stored which is allocated to the target cell, a set of communication resources (e.g. a PRACH preamble and C-RNTI pair) is selected which is to be assigned to the handover procedure for the UE 10. This selected set of communication resources is then signaled to the UE 10 by transmitting access information related to the handover to the target cell.

In S250, information that the fast handover procedure is completed to the target cell is received and processed, wherein the information is sent by the target eNB (eNB B 20). According to some examples of embodiments, as a further option in connection with the information about the completion of the handover, information indicating a modification of the content of the pool of communication resources allocated by the neighboring cell is received and processed, wherein the modification comprises removing or replacing of the selected set of communication resources used in the fast handover procedure.

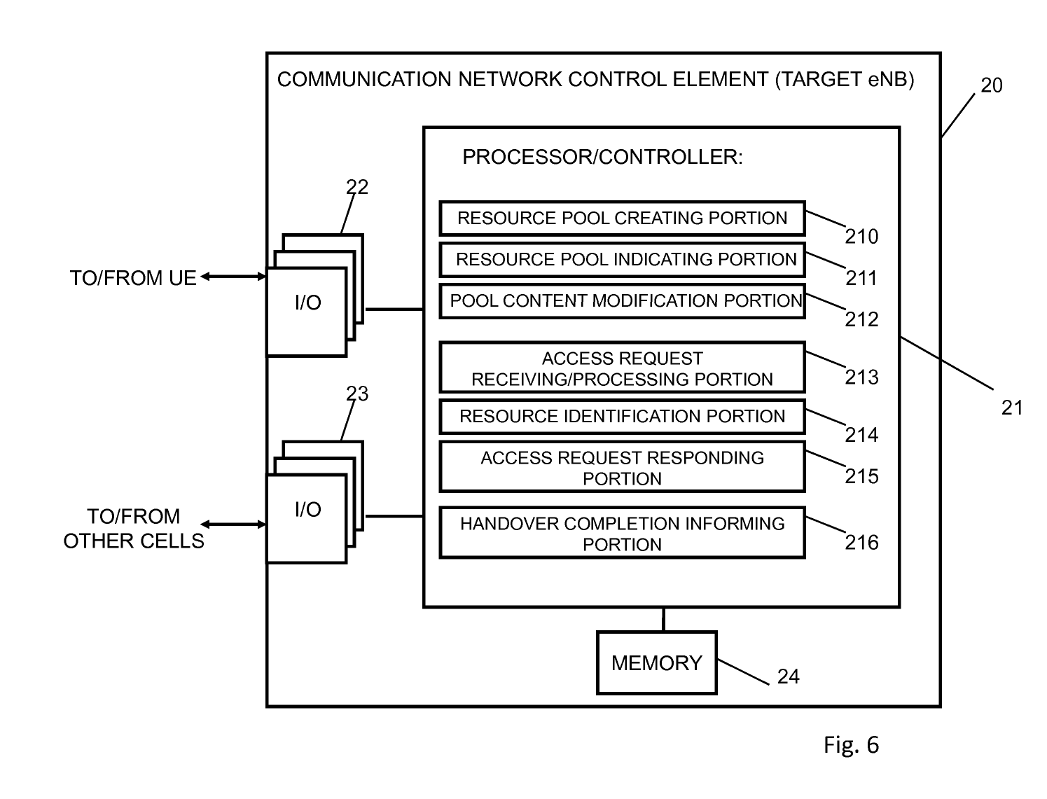

In FIG. 6, a diagram illustrating a configuration of a communication network control element, such as of the eNB B 20, is shown, which is configured to implement the handover procedure as described in connection with some of the examples of embodiments. It is to be noted that the communication network control element like the eNB B 20 shown in FIG. 6 may comprise further elements or functions besides those described herein below. Furthermore, even though reference is made to an eNB, the communication network control element may be also another device having a similar function, such as a chipset, a chip, a module etc., which can also be part of a communication network control element or attached as a separate element to a communication network control element, or the like. It should be understood that each block and any combination thereof may be implemented by various means or their combinations, such as hardware, software, firmware, one or more processors and/or circuitry.

The communication network control element shown in FIG. 6 may comprise a processing function, control unit or processor 21, such as a CPU or the like, which is suitable for executing instructions given by programs or the like related to the handover procedure. The processor 21 may comprise one or more processing portions dedicated to specific processing as described below, or the processing may be run in a single processor. Portions for executing such specific processing may be also provided as discrete elements or within one or more further processors or processing portions, such as in one physical processor like a CPU or in several physical entities, for example. Reference signs 22 and 23 denote transceiver or input/output (I/O) units (interfaces) connected to the processor 21. The I/O units 22 may be used for communicating with one or more communication elements like UEs. The I/O units 23 may be used for communicating with one or more network elements, like neighboring eNBs, and the core network. The I/O units 22 and 23 may be a combined unit comprising communication equipment towards several network elements, or may comprise a distributed structure with a plurality of different interfaces for different network elements. Reference sign 24 denotes a memory usable, for example, for storing data and programs to be executed by the processor 21 and/or as a working storage of the processor 21.

The processor 21 is configured to execute processing related to the above described handover procedure. In particular, the processor 21 comprises a sub-portion 210 as a processing portion which is usable for creating at least one pool of communication resources. The portion 210 may be configured to perform processing according to S100 of FIG. 4. Furthermore, the processor 21 comprises a sub-portion 211 usable as a portion for indicating the content of the pool of communication resources. The portion 211 may be configured to perform processing according to S110 of FIG. 4. Furthermore, the processor 21 comprises a sub-portion 212 usable as a portion for conducting a modification processing at the pool of communication resources. The portion 212 may be configured to perform a processing according to S115 of FIG. 4. In addition, the processor 21 comprises a sub-portion 213 usable as a portion for receiving and processing an access request from a UE. The portion 213 may be configured to perform a processing according to S120 of FIG. 4. Moreover, the processor 21 comprises a sub-portion 214 usable as a portion for identifying a resource on the basis of the information indicating the content of the pool of communication resources. The portion 214 may be configured to perform a processing according to S130 of FIG. 4. In addition, the processor 21 comprises a sub-portion 215 usable as a portion for responding to the access request. The portion 215 may be configured to perform a processing according to S130 and S140 of FIG. 4. Furthermore, the processor 21 comprises a sub-portion 216 usable as a portion for informing about the completion of the handover. The portion 217 may be configured to perform a processing according to S150 of FIG. 4.

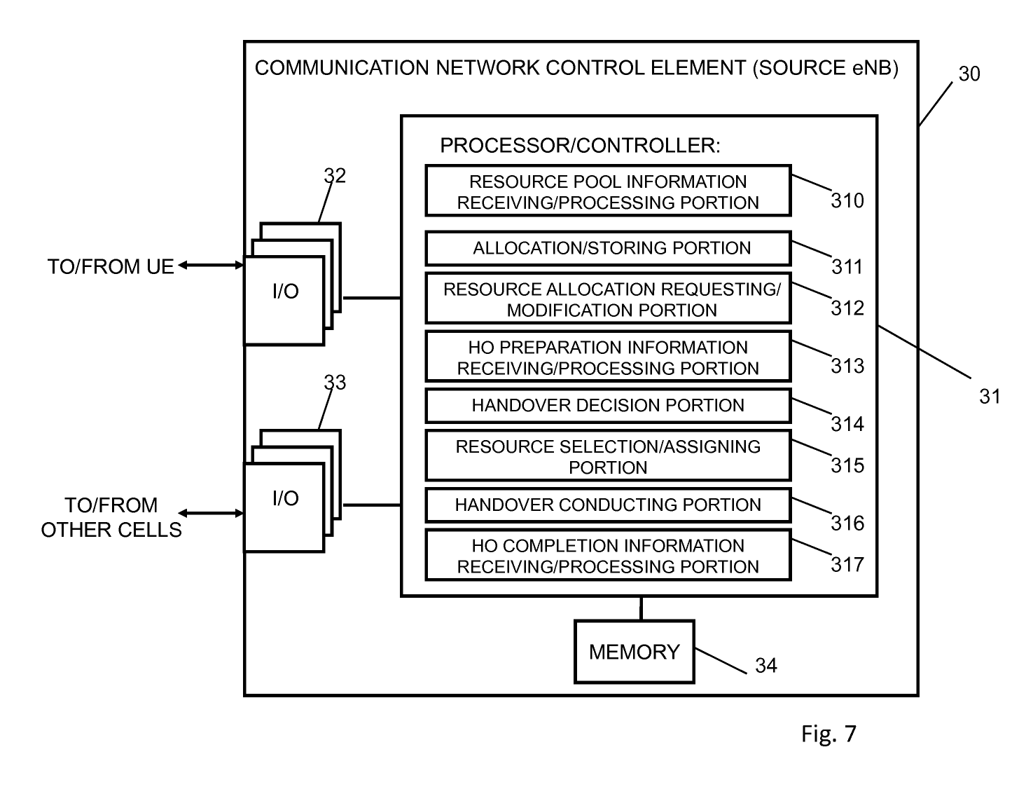

In FIG. 7, a diagram illustrating a configuration of a communication network control element, such as of the eNB A 30, is shown, which is configured to implement the handover procedure as described in connection with some of the examples of embodiments. It is to be noted that the communication network control element like the eNB A 30 shown in FIG. 7 may comprise several further elements or functions besides those described herein below. Furthermore, even though reference is made to an eNB, the communication network control element may be also another device having a similar function, such as a chipset, a chip, a module etc., which can also be part of a communication network control element or attached as a separate element to a communication network control element, or the like. It should be understood that each block and any combination thereof may be implemented by various means or their combinations, such as hardware, software, firmware, one or more processors and/or circuitry.

The communication network control element shown in FIG. 7 may comprise a processing function, control unit or processor 31, such as a CPU or the like, which are suitable for executing instructions given by programs or the like related to the handover procedure. The processor 31 may comprise one or more processing portions dedicated to specific processing as described below, or the processing may be run in a single processor. Portions for executing such specific processing may be also provided as discrete elements or within one or more further processors or processing portions, such as in one physical processor like a CPU or in several physical entities, for example. Reference signs 32 and 33 denote transceiver or input/output (I/O) units (interfaces) connected to the processor 31. The I/O units 32 may be used for communicating with one or more communication elements like UEs. The I/O units 33 may be used for communicating with one or more network elements, like neighboring eNBs, and the core network. The I/O units 32 and 33 may be a combined unit comprising communication equipment towards several network elements, or may comprise a distributed structure with a plurality of different interfaces for different network elements. Reference sign 34 denotes a memory usable, for example, for storing data and programs to be executed by the processor 31 and/or as a working storage of the processor 31.

The processor 31 is configured to execute processing related to the above described handover procedure. In particular, the processor 31 comprises a sub-portion 310 as a processing portion which is usable for receiving and processing information indicating a content of a pool of communication resources. The portion 310 may be configured to perform processing according to S200 of FIG. 5. Furthermore, the processor 31 comprises a sub-portion 311 usable as a portion for allocating the pool of communication resources to a neighboring cell and for storing corresponding information. The portion 311 may be configured to perform processing according to S210 of FIG. 5. Furthermore, the processor 31 comprises a sub-portion 312 usable as a portion for requesting and/or conducting a modification processing at the pool of communication resources. The portion 312 may be configured to perform a processing according to S215 of FIG. 5. In addition, the processor 31 comprises a sub-portion 313 usable as a portion for receiving and processing handover preparation information. The portion 313 may be configured to perform a processing according to S220 of FIG. 5. Moreover, the processor 31 comprises a sub-portion 314 usable as a portion for deciding on performing a handover. The portion 314 may be configured to perform a processing according to S220 of FIG. 5. In addition, the processor 31 comprises a sub-portion 315 usable as a portion for selecting and assigning resources. The portion 315 may be configured to perform a processing according to S230 and S240 of FIG. 5. Furthermore, the processor 31 comprises a sub-portion 316 usable as a portion for conducting a handover. The portion 316 may be configured to perform a processing according to S240 or S260 of FIG. 5. Moreover, the processor 31 comprises a sub-portion 317 usable as a portion for receiving and processing information about the completion of the handover. The portion 317 may be configured to perform a processing according to S250 of FIG. 5.

As described above, according to some examples of embodiments, each set of communication resources comprises one dedicated preamble for a random access channel (PRACH preamble) and one temporary identifier in a cell radio network (C-RNTI) being associated to the dedicated preamble of the random access channel. However, according to some further examples of embodiments, the set of communication resources comprises further parameters besides the C-RNTI and PRACH preamble, for example target eNB security algorithm identifiers for selected security algorithms or the like.

Even though it is described above that a handover is to be executed from the small eNB A 30 to the macro eNB B 20, it is of course also possible that the direction is inverse, which requires that pools of communication resources are provided e.g. from the eNB A 30 to the eNB B 20 at the same time. For example, a corresponding exchange of pools of communication resources between two (or more) communication network control elements is triggered when one of the communication network control elements requests the allocation of communication resources for a fast handover from another communication network control element. Also a handover with the eNB C 40 as the target cell, for example, may be conducted according to the same principles.

Moreover, the involved communication network control element is not restricted to an eNB, that is the target cell or source cell according to some examples of embodiments of the invention may be controlled by another network node type, e.g. a BS or the like.

According to a further example of embodiments, there is provided an apparatus comprising resource pool creating means configured to create at least one pool of communication resources for a fast handover procedure, wherein at least one set of communication resources is allocated to a pool of communication resources, and resource pool indicating means configured to cause a transmission of information indicating the content of the at least one pool of communication resources to a neighboring cell for allocating the pool of communication resources to the neighboring cell.

In addition, the apparatus according to this example of embodiments may comprise additional means for carrying out a processing as described in connection with a communication network control element acting as a target eNB, for example, as described in connection with FIGS. 2, 3, and 4, wherein such means may comprise at least one of the following means:
resource amount determination means configured to determine a required number of sets of communication resources for a pool of communication resources on the basis of an estimated amount of usage of a random access procedure and an available amount of communication resources, wherein the resource pool creating means are further configured to create the at least one pool of communication resources for the fast handover procedure on the basis of the determined required number of sets of communication resources and the available amount of communication resources;
resource allocation request receiving and processing means configured to receive and process a request for allocating a specified amount of sets of communication resources for conducting a fast handover procedure, wherein the resource amount determination means are further configured to determine the required number of sets of communication resources on the basis of the specified amount of sets of communication resources indicated in the request;
pool content modification means configured to conduct a modification processing for changing a content of a pool of communication resources allocated to a neighboring cell, the modification processing comprises at least one of increasing and decreasing of the number of sets of communication resources allocated to the pool of communication resources and replacing at least one of the sets of communication resources allocated to the pool of communication resources, wherein the resource pool indicating means are further configured to cause a transmission of information indicating the modified content of the pool of communication resources to the neighboring cell;
modification request receiving and processing means configured to receive and process a modification request for modifying a content of an allocated pool of communication resources, wherein the pool content modification means are further configured to conduct the modification processing on the basis of the modification request;
acknowledgement receiving and processing means configured to receive an process an acknowledgement for accepting a modified pool of communication resources at the neighboring cell;
access request receiving and processing means configured to receive and process an access request from a communication element requesting an establishment of a communication connection, wherein the access request uses communication resources allocated to the at least one pool of communication resources for a fast handover procedure, resource identification means configured to identify the at least one pool of communication resources and the corresponding allocated set of communication resources on the basis of the communication resources used in the access request, and access request responding means configured to cause a transmission of a response to the access request on the basis of the identified set of communication resources for conducting a fast handover procedure with the communication element; the access request receiving and processing means may be further configured to determine in the access request the usage of a preamble for a random access channel comprised in the set of communication resources, the resource identification function means may be further configured to identify, on the basis of the determined preamble for the random access channel, a temporary identifier in a cell radio network associated to the preamble of the random access channel in the set of communication resources, and the access request responding function means may be further configured to cause a transmission of a response to the access request being signed with the identified temporary identifier;
handover completion informing means configured to inform, when the fast handover procedure is completed, the neighboring cell to which the pool of communication resources comprising the set of communication resources used in the access request and the fast handover procedure has been allocated about the completion of the fast handover procedure with the communication element;
pool content modification means configured to conduct a modification processing for changing the content of the pool of communication resources allocated to the neighboring cell by removing or replacing the set of communication resources used in access request and the fast handover procedure, wherein the resource pool indicating means are further configured to cause a transmission of information indicating the modified content of the pool of communication resources to the neighboring cell.

Furthermore, according to a further example of embodiments, there is provided an apparatus comprising resource pool information receiving and processing means configured to receive, from a neighboring cell, and process information indicating a content of a pool of communication resources for a fast handover procedure, wherein at least one set of communication resources is allocated to the pool of communication resources, wherein the processing comprises to allocate the received pool of communication resources to the neighboring cell and to store the information indicating the content of the pool of communication resources.

In addition, the apparatus according to this example of embodiments may comprise additional means for carrying out a processing as described in connection with a communication network control element acting as a source eNB, for example, as described in connection with FIGS. 2, 3, and 5, wherein such means may comprise at least one of the following means:
resource allocation requesting means configured to request an allocation of a specified number of sets of communication resources for conducting a fast handover procedure from the neighboring cell;
resource amount determination means configured to determine a required number of sets of communication resources for a fast handover procedure on the basis of an estimated amount of usage of a random access procedure, wherein the resource allocation requesting means are further configured to request the specified number of sets of communication resources on the basis of the determined required number of sets of communication resources;
pool content modification requesting means configured to request a modification processing for changing the content of the pool of communication resources allocated by the neighboring cell, the modification processing comprises at least one of increasing and decreasing of the number of sets of communication resources allocated to the pool of communication resources and replacing at least one of the sets of communication resources allocated to the pool of communication resources;
pool content modification receiving and processing means configured to receive and process an information indicating a modification of the content of the pool of communication resources allocated by the neighboring cell, wherein the modification comprises at least one of increasing and decreasing of the number of sets of communication resources allocated to the pool of communication resources and replacing at least one of the sets of communication resources allocated to the pool of communication resources;
acknowledgement means configured to cause a transmission of an acknowledgement to the neighboring cell indicating acceptance of the modified pool of communication resources;
handover preparation information receiving and processing means configured to receive and process information regarding preparation of a handover procedure to be conducted for a communication element, handover decision means configured to decide on conducting a handover procedure and to determine a target cell of the handover procedure on the basis of the information regarding preparation of a handover procedure, selection means configured to select, when for the target cell of the handover procedure information indicating a content of a pool of communication resources for a fast handover procedure is stored which is allocated to the target cell, a set of communication resources to be assigned to the handover procedure for the communication element, and handover information providing means configured to cause a transmission of access information related to the handover to the target cell, the information comprising an indication of the selected set of communication resources;
handover completion information receiving and processing means configured to receive and process an information that the fast handover procedure is completed to the target cell;
pool content modification receiving and processing means configured to receive and process an information indicating a modification of the content of the pool of communication resources allocated by the neighboring cell, wherein the modification comprises removing or replacing of the selected set of communication resources used in the fast handover procedure.

It should be appreciated that
an access technology via which signaling is transferred to and from a network element may be any suitable present or future technology, such as WLAN (Wireless Local Access Network), WiMAX (Worldwide Interoperability for Microwave Access), LTE, LTE-A, Bluetooth, Infrared, and the like may be used; Additionally, embodiments may also apply wired technologies, e.g. IP based access technologies like cable networks or fixed lines—a user device (also called UE, user equipment, user terminal, terminal device, etc.) illustrates one type of an apparatus to which resources on the air interface may be allocated and assigned, and thus any feature described herein with a user device may be implemented with a corresponding apparatus, such as a relay node. An example of such a relay node is a layer 3 relay (self-backhauling relay) towards the base station or eNodeB. The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example is a camera or video camera loading images or video clips to a network. It should be appreciated that a device may be regarded as an apparatus or as an assembly of more than one apparatus, whether functionally in cooperation with each other or functionally independently of each other but in a same device housing.
embodiments suitable to be implemented as software code or portions of it and being run using a processor are software code independent and can be specified using any known or future developed programming language, such as a high-level programming language, such as objective-C, C, C++, C#, Java, etc., or a low-level programming language, such as a machine language, or an assembler—implementation of embodiments, is hardware independent and may be implemented using any known or future developed hardware technology or any hybrids of these, such as a microprocessor or CPU (Central Processing Unit), MOS (Metal Oxide Semiconductor), CMOS (Complementary MOS), BiMOS (Bipolar MOS), BiCMOS (Bipolar CMOS), ECL (Emitter Coupled Logic), and/or TTL (Transistor-Transistor Logic)—embodiments may be implemented as individual devices, apparatuses, units or means or in a distributed fashion, for example, one or more processors may be used or shared in the processing, or one or more processing sections or processing portions may be used and shared in the processing, wherein one physical processor or more than one physical processor may be used for implementing one or more processing portions dedicated to specific processing as described,
an apparatus may be implemented by a semiconductor chip, a chipset, or a (hardware) module comprising such chip or chipset—embodiments may also be implemented as any combination of hardware and software, such as ASIC (Application Specific IC (Integrated Circuit)) components, FPGA (Field-programmable Gate Arrays) or CPLD (Complex Programmable Logic Device) components or DSP (Digital Signal Processor) components.
embodiments may also be implemented as computer program products, comprising a computer usable medium having a computer readable program code embodied therein, the computer readable program code adapted to execute a process as described in embodiments, wherein the computer usable medium may be a non-transitory medium.

Although the present invention has been described herein before with reference to particular embodiments thereof, the present invention is not limited thereto and various modifications can be made thereto.

1. An apparatus comprising
at least one processor, and
at least one memory for storing instructions to be executed by the processor, wherein
the at least one memory and the instructions are configured to, with the at least one processor, cause the apparatus at least:
to create at least one pool of communication resources for a fast handover procedure, wherein at least one set of communication resources is allocated to a pool of communication resources, and
to cause a transmission of information indicating the content of the at least one pool of communication resources to a neighboring cell for allocating the pool of communication resources to the neighboring cell.

2. The apparatus according to claim 1, wherein, in case a pool of communication resources is to be allocated to more than one neighboring cell, the at least one memory and the instructions are further configured to, with the at least one processor, cause the apparatus to create a separate pool of communication resources for a fast handover procedure for each of the neighboring cells, and to cause a transmission of information indicating the content of each of the separate pools of communication resources to a corresponding neighboring cell for allocating the pool of communication resources to the neighboring cell.

3. The apparatus according to claim 1, wherein the at least one memory and the instructions are further configured to, with the at least one processor, cause the apparatus at least:
to determine a required number of sets of communication resources for a pool of communication resources on the basis of an estimated amount of usage of a random access procedure and an available amount of communication resources,
wherein the at least one memory and the instructions are further configured to, with the at least one processor, cause the apparatus to create the at least one pool of communication resources for the fast handover procedure on the basis of the determined required number of sets of communication resources and the available amount of communication resources.

4. The apparatus according to claim 3, wherein the at least one memory and the instructions are further configured to, with the at least one processor, cause the apparatus at least:
to receive and process a request for allocating a specified amount of sets of communication resources for conducting a fast handover procedure,
wherein the at least one memory and the instructions are further configured to, with the at least one processor, cause the apparatus to determine the required number of sets of communication resources on the basis of the specified amount of sets of communication resources indicated in the request.

5. The apparatus according to claim 1, wherein the at least one memory and the instructions are further configured to, with the at least one processor, cause the apparatus at least:
to conduct a modification processing for changing a content of a pool of communication resources allocated to a neighboring cell, the modification processing comprises at least one of increasing and decreasing of the number of sets of communication resources allocated to the pool of communication resources and replacing at least one of the sets of communication resources allocated to the pool of communication resources,
wherein the at least one memory and the instructions are further configured to, with the at least one processor, cause the apparatus to cause a transmission of information indicating the modified content of the pool of communication resources to the neighboring cell.

6. The apparatus according to claim 5, wherein the at least one memory and the instructions are further configured to, with the at least one processor, cause the apparatus at least:
to receive and process a modification request for modifying a content of an allocated pool of communication resources,
wherein the at least one memory and the instructions are further configured to, with the at least one processor, cause the apparatus to conduct the modification processing on the basis of the modification request.

7. (canceled)

8. The apparatus according to claim 1, wherein the set of communication resources comprises at least one dedicated preamble for a random access channel and one temporary identifier in a cell radio network, the temporary identifier being associated to the dedicated preamble of the random access channel.

9. The apparatus according to claim 1, wherein the at least one memory and the instructions are further configured to, with the at least one processor, cause the apparatus at least:
to receive and process an access request from a communication element requesting an establishment of a communication connection, wherein the access request uses communication resources allocated to the at least one pool of communication resources for a fast handover procedure,
to identify the at least one pool of communication resources and the corresponding allocated set of communication resources on the basis of the communication resources used in the access request, and
to cause a transmission of a response to the access request on the basis of the identified set of communication resources for conducting a fast handover procedure with the communication element.

10. The apparatus according to claim 9, wherein
the at least one memory and the instructions are further configured to, with the at least one processor, cause the apparatus to determine in the access request the usage of a preamble for a random access channel comprised in the set of communication resources,
the at least one memory and the instructions are further configured to, with the at least one processor, cause the apparatus to identify, on the basis of the determined preamble for the random access channel, a temporary identifier in a cell radio network associated to the preamble of the random access channel in the set of communication resources, and
the at least one memory and the instructions are further configured to, with the at least one processor, cause the apparatus to cause a transmission of a response to the access request being signed with the identified temporary identifier.

11. The apparatus according to claim 9, wherein the at least one memory and the instructions are further configured to, with the at least one processor, cause the apparatus at least:
to inform, when the fast handover procedure is completed, the neighboring cell to which the pool of communication resources comprising the set of communication resources used in the access request and the fast handover procedure has been allocated about the completion of the fast handover procedure with the communication element.

12. The apparatus according to claim 11, wherein the at least one memory and the instructions are further configured to, with the at least one processor, cause the apparatus at least:
to conduct a modification processing for changing the content of the pool of communication resources allocated to the neighboring cell by removing or replacing the set of communication resources used in access request and the fast handover procedure,
wherein the at least one memory and the instructions are further configured to, with the at least one processor, cause the apparatus to cause a transmission of information indicating the modified content of the pool of communication resources to the neighboring cell.

13. (canceled)

14. A method comprising
creating at least one pool of communication resources for a fast handover procedure, wherein at least one set of communication resources is allocated to a pool of communication resources, and
causing a transmission of information indicating the content of the at least one pool of communication resources to a neighboring cell for allocating the pool of communication resources to the neighboring cell.

15-26. (canceled)

27. An apparatus comprising
at least one processor, and
at least one memory for storing instructions to be executed by the processor, wherein
the at least one memory and the instructions are configured to, with the at least one processor, cause the apparatus at least:
to receive and process information indicating a content of a pool of communication resources for a fast handover procedure, wherein at least one set of communication resources is allocated to the pool of communication resources,
wherein the processing comprises to allocate the received pool of communication resources to a neighboring cell and to store the information indicating the content of the pool of communication resources.

28. The apparatus according to claim 27, wherein the at least one memory and the instructions are further configured to, with the at least one processor, cause the apparatus at least:
to request an allocation of a specified number of sets of communication resources for conducting a fast handover procedure from the neighboring cell.

29. The apparatus according to claim 28, wherein the at least one memory and the instructions are further configured to, with the at least one processor, cause the apparatus at least:
to determine a required number of sets of communication resources for a fast handover procedure on the basis of an estimated amount of usage of a random access procedure,
wherein the at least one memory and the instructions are further configured to, with the at least one processor, cause the apparatus to request the specified number of sets of communication resources on the basis of the determined required number of sets of communication resources.

30. The apparatus according to claim 27, wherein the at least one memory and the instructions are further configured to, with the at least one processor, cause the apparatus at least:
to request a modification processing for changing the content of the pool of communication resources allocated by the neighboring cell, the modification processing comprises at least one of increasing and decreasing of the number of sets of communication resources allocated to the pool of communication resources and replacing at least one of the sets of communication resources allocated to the pool of communication resources.

31. The apparatus according to claim 27, wherein the at least one memory and the instructions are further configured to, with the at least one processor, cause the apparatus at least:
to receive and process an information indicating a modification of the content of the pool of communication resources allocated by the neighboring cell, wherein the modification comprises at least one of increasing and decreasing of the number of sets of communication resources allocated to the pool of communication resources and replacing at least one of the sets of communication resources allocated to the pool of communication resources.

32. (canceled)

33. The apparatus according to claim 27, wherein the set of communication resources comprises at least one dedicated preamble for a random access channel and one temporary identifier in a cell radio network, the temporary identifier being associated to the dedicated preamble of the random access channel.

34. The apparatus according to claim 27, wherein the at least one memory and the instructions are further configured to, with the at least one processor, cause the apparatus at least:
to receive and process information regarding preparation of a handover procedure to be conducted for a communication element,
to decide on conducting a handover procedure and to determine a target cell of the handover procedure on the basis of the information regarding preparation of a handover procedure,
to select, when for the target cell of the handover procedure information indicating a content of a pool of communication resources for a fast handover procedure is stored which is allocated to the target cell, a set of communication resources to be assigned to the handover procedure for the communication element, and
to cause a transmission of access information related to the handover to the target cell, the information comprising an indication of the selected set of communication resources.

35. (canceled)

36. The apparatus according to claim 34, wherein the at least one memory and the instructions are further configured to, with the at least one processor, cause the apparatus at least:
to receive and process an information that the fast handover procedure is completed to the target cell.

37. The apparatus according to claim 36, wherein the at least one memory and the instructions are further configured to, with the at least one processor, cause the apparatus at least:
to receive and process an information indicating a modification of the content of the pool of communication resources allocated by the neighboring cell, wherein the modification comprises removing or replacing of the selected set of communication resources used in the fast handover procedure.

38. (canceled)

39-55. (canceled)
